(19) United States
(12) Patent Application Publication
(10) Pub. No.: US 2024/0307839 A1
(43) Pub. Date: Sep. 19, 2024

(54) METHODS FOR CONTROLLING CATALYST FLOW IN FLUIDIZED CATALYTIC PROCESSING SYSTEMS

(71) Applicant: Dow Global Technologies LLC, Midland, MI (US)

(72) Inventors: Matthew T. Pretz, Freeport, TX (US); Adam M. McNeeley, Blacksburg, VA (US); Yang Yang, Freeport, TX (US)

(73) Assignee: Dow Global Technologies LLC, Midland, MI (US)

(21) Appl. No.: 18/547,031

(22) PCT Filed: Mar. 21, 2022
(86) PCT No.: PCT/US2022/021115

§ 371 Date: Aug. 18, 2023

Related U.S. Application Data
(60) Provisional application No. 63/165,254, filed on Mar. 24, 2021.

(51) Int. Cl. B01J 8/18; B01J 8/00; B01J 8/28

(52) U.S. Cl. CPC B01J 8/1809; B01J 8/0055; B01J 8/28; B01J 2208/00548; B01J 2208/027

(57) ABSTRACT

According to one or more embodiments, the flow of catalyst in a fluidized catalytic processing system may be controlled by a method including determining the amount of catalyst present in a first catalyst bed of the fluidized catalytic processing system. The fluidized catalytic processing system may include a first catalyst bed, a second catalyst bed, a third catalyst bed, and a fourth catalyst bed. The method may include comparing the amount of catalyst present in the first catalyst bed with a threshold catalyst amount. When the amount of catalyst present in the first catalyst bed is less than the threshold catalyst amount, the method may include regulating flow of catalyst from the second catalyst bed to the third catalyst bed such that an increased target amount of catalyst is maintained in the second catalyst bed.

### CROSS-REFERENCE TO RELATED APPLICATIONS

This application claims the benefit of and priority to U.S. Application Ser. No. 63/165,254 filed on Mar. 24, 2021, and entitled “Methods for Controlling Catalyst Flow in Fluidized Catalytic Processing Systems,” the entire contents of which are incorporated by reference in the present disclosure.

### TECHNICAL FIELD

Embodiments described herein generally relate to chemical processing and, more specifically, to methods for controlling catalyst flow.

### BACKGROUND

Many chemicals are produced through processes employing solid particulate catalysts that may pass between multiple fluidized beds. During those processes, the catalyst in a reactor system may by cycled between a reactor unit and a regeneration unit. For example, catalyst may need to be regenerated if they become “spent” and have reduced activity in subsequent reactions. In addition, endothermic processes require heat, and the catalyst may need to be reheated in the regeneration unit if it is the primary medium of transfer for heat into the reactor. Following regeneration in the regeneration unit, the regenerated catalyst may be transferred back to fluidized beds in the reactor for use in subsequent reactions.

### SUMMARY

In some embodiments of fluidized bed reactors where catalyst is regenerated, four catalyst beds are present through which catalyst circulates. For example, two of the beds are the reactor and regenerator, and the two additional beds are collection areas following the reactor and regenerator sections, such as following a separation step. While such systems are relatively widely-used, consideration should be given to the transfer of catalyst between reactor and regenerator sections of a system, particularly for non-steady state operating conditions.

There is a need for improved methods for controlling the flow of catalyst through such fluidized catalytic processing systems having four beds. Many conventional strategies for controlling the flow of catalyst through fluidized catalytic processing systems may result in excessive accumulation of catalyst in a single catalyst bed during system upsets (i.e., non-steady state conditions). Such conventional strategies may result in the flooding of catalyst separation equipment or the need to oversize process equipment to accommodate the accumulation of catalyst in a single vessel. However, it has been discovered that when the amount of catalyst in a first catalyst bed is below a threshold amount of catalyst, regulating the flow of catalyst from a second catalyst bed to a third catalyst bed such that an increased amount of catalyst is maintained in the second catalyst bed may prevent excessive accumulation of catalyst in a fourth catalyst bed. For example, some of the methods disclosed herein may include adjusting the flow of catalyst between the second catalyst bed and the third catalyst bed during system upsets, where the amount of catalyst in the first catalyst bed is low, such as when flow of catalyst between the fourth catalyst bed and the first catalyst bed is interrupted. These methods may result in the improved distribution of catalyst through the fluidized catalytic processing system during system upsets, since the catalyst may accumulate in both the second catalyst bed and the fourth catalyst bed, instead of only in the fourth catalyst bed. For example, embodiments of the control methods described herein may reduce the probability of catalyst flooding process equipment, including catalyst separation equipment, that may be negatively impacted by an excessive amount of catalyst accumulating in the fourth catalyst bed. Furthermore, embodiments of the control methods described herein may reduce the need for process equipment that is oversized to accommodate the accumulation of catalyst in a single fluidized bed, such as the fourth catalyst bed, since catalyst may accumulate in both the second and fourth catalyst beds.

According to one or more embodiments disclosed herein, the flow of catalyst in a fluidized catalytic processing system may be controlled by a method comprising determining the amount of catalyst present in a first catalyst bed of the fluidized catalytic processing system. The fluidized catalytic processing system may comprise a first catalyst bed, a second catalyst bed, a third catalyst bed, and a fourth catalyst bed. The first catalyst bed may be in fluid communication with the second catalyst bed. The second catalyst bed may be in fluid communication with the third catalyst bed. The third catalyst bed may be in fluid communication with the fourth catalyst bed. The fourth catalyst bed may be in fluid communication with the first catalyst bed. The catalyst may circulate from the first catalyst bed to the second catalyst bed, from the second catalyst bed to the third catalyst bed, from the third catalyst bed to the fourth catalyst bed, and from the fourth catalyst bed to the first catalyst bed. Flow from the second catalyst bed to the third catalyst bed may be regulated to adjust the amount of catalyst in the second catalyst bed. The method may further comprise comparing the amount of catalyst present in the first catalyst bed with a threshold catalyst amount. When the amount of catalyst present in the first catalyst bed is greater than or equal to the threshold catalyst amount, the method may comprise regulating the flow of catalyst from the second catalyst bed to the third catalyst bed such that a normal operating target amount of catalyst is maintained in the second catalyst bed. When the amount of catalyst present in the first catalyst bed is less than the threshold catalyst amount, the method may comprise regulating flow of catalyst from the second catalyst bed to the third catalyst bed such that an increased target amount of catalyst is maintained in the second catalyst bed.

It is to be understood that both the foregoing brief summary and the following detailed description present embodiments of the technology, and are intended to provide an overview or framework for understanding the nature and character of the technology as it is claimed. The accompanying drawings are included to provide a further understanding of the technology, and are incorporated into and constitute a part of this specification. The drawings illustrate various embodiments and, together with the description, serve to explain the principles and operations of the technology. Additionally, the drawings and descriptions are meant to be merely illustrative, and are not intended to limit the scope of the claims in any manner.

Additional features and advantages of the technology disclosed herein will be set forth in the detailed description that follows, and in part will be readily apparent to those skilled in the art from that description or recognized by practicing the technology as described herein, including the detailed description that follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a fluidized catalytic processing system, according to one or more embodiments described herein;

FIG. 2 schematically depicts a fluidized catalytic system, according to one or more embodiments described herein; and

FIG. 3 schematically depicts a reactor section of a fluidized catalytic system, according to one or more embodiments described herein;

It should be understood that the drawings are schematic in nature, and do not include some components of a fluidized catalyst processing system commonly employed in the art, such as, without limitation, temperature transmitters, pressure transmitters, flow meters, pumps, valves, and the like. It would be known that these components are within the spirit and scope of the present embodiments disclosed. However, operational components, such as those described in the present disclosure, may be added to the embodiments described in this disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

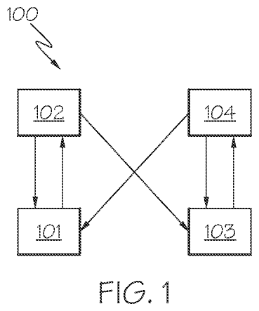

Methods described herein may be utilized to control the catalyst flow in a fluidized catalytic processing system. Such methods utilize systems that have particular features, such as a particular orientation of system parts. FIG. 1 depicts such a system, which includes four catalyst beds, which may be fluidized beds. Catalyst may be passed between the four catalyst beds as depicted in FIG. 1 and the flow of catalyst from one catalyst bed to another may be regulated to prevent excessive accumulation of catalyst in any one catalyst bed. While all four beds may be fluidized beds, as described in some embodiments herein, it should be appreciated that the general concepts of the present application may be applied to any type of catalyst beds.

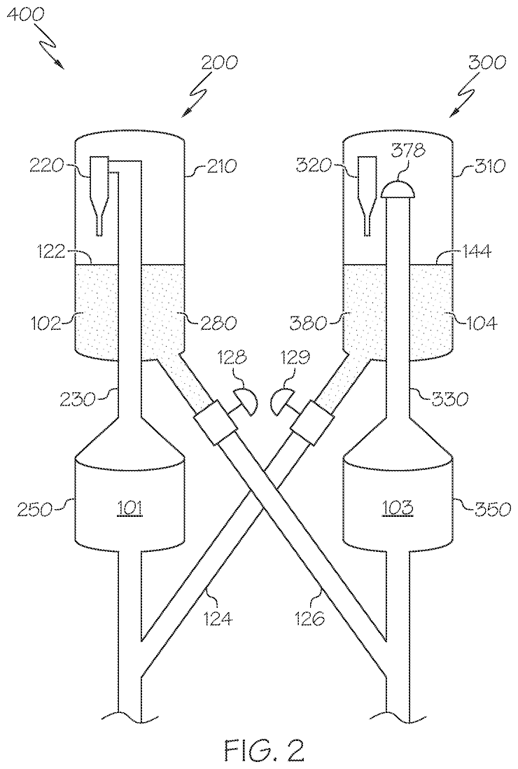

Additionally, in one or more embodiments described herein, the fluidized catalytic processing system may comprise a fluidized catalytic dehydrogenation process comprising at least a reactor and a regenerator. One particular embodiment, which is disclosed in detail herein, is depicted in FIG. 2. However, it should be understood that the principles disclosed and taught herein may be applicable to other systems which utilize different system components oriented in different ways, or different reaction schemes utilizing various catalyst compositions.

Now referring to FIG. 1, as may be understood with reference to the forgoing figures and description, a fluidized catalytic processing system 100 may comprise a first catalyst bed 101, a second catalyst bed 102, a third catalyst bed 103, and a fourth catalyst bed 104. In one or more embodiments, the first catalyst bed 101 may be in fluid communication with the second catalyst bed 102. The second catalyst bed 102 may be in fluid communication with the third catalyst bed 103. The third catalyst bed 103 may be in fluid communication with the fourth catalyst bed 104. And, the fourth catalyst bed 104 may be in fluid communication with the first catalyst bed 101. As described herein, system components may be in “fluid communication” when a fluid or fluidized solid may be passed between system components. System components in fluid communication may be directly connected, or may be connected by conduit, pipe, or other suitable intervening structure.

In one or more embodiments, catalyst may circulate from the first catalyst bed 101 to the second catalyst bed 102, from the second catalyst bed 102 to the third catalyst bed 103, from the third catalyst bed 103 to the fourth catalyst bed 104, and from the fourth catalyst bed 104 to the first catalyst bed 101. In one or more embodiments, catalyst may be recycled from the second catalyst bed 102 to the first catalyst bed 101. In one or more embodiments, catalyst may be recycled from the fourth catalyst bed 104 to the third catalyst bed 103.

Each of the first catalyst bed 101, the second catalyst bed 102, the third catalyst bed 103, and the fourth catalyst bed 104 may be contained within separate vessels. The vessels may be any suitable vessels, including but not limited to drums, barrels, vats, tanks, and any other container suitable for containing a fluidized bed. The vessels may be generally cylindrical in shape (i.e., having a substantially circular diameter), or may alternately be non-cylindrically shaped, such as prism shaped with cross-sectional shaped of triangles, rectangles, pentagons, hexagons, octagons, ovals, or other polygons or curved closed shapes, or combinations thereof. The vessels may be fluidly coupled to allow catalyst to pass between the catalyst beds.

In one or more embodiments, each of the first catalyst bed 101, the second catalyst bed 102, the third catalyst bed 103, and the fourth catalyst bed 104 may comprise a dense fluidized bed or a fast fluidized bed. As described herein, a “dense fluidized bed” refers to a fluidized bed having a clearly defined upper limit or surface. For example, a dense fluidized bed may include such fluidization regimes as smooth fluidization, bubbling fluidization, and slugging fluidization. In a dense fluidized bed, the particle entrainment rate may be low, but may increase as the velocity of the gas flowing through the bed increases.

As described herein, a “fast fluidized bed” refers to a fluidized bed where there is no clear upper limit to the fluidized bed. Instead, particles are dispersed throughout the vessel containing the fluidized bed. The particles in a fast fluidized bed are transported out of the fluidized bed with the gas flowing through the fluidized bed, and particles are generally added to the fast fluidized bed to replace the particles transported out of the bed.

As described herein, “turbulent fluidized bed” may refer to a fluidized bed that is in a transition state between a dense fluidized bed and a fast fluidized bed. In some cases, turbulent fluidized beds may exhibit no clear upper limit, like fast fluidized beds. In some cases, turbulent fluidized beds may exhibit bubbling, like dense fluidized beds; however, the bubbles in turbulent fluidized beds may consistently break, resulting in a more even distribution of particles than is observed in bubbling or slugging fluidized beds.

In one or more embodiments, the first catalyst bed 101 may comprise a turbulent fluidized bed, the second catalyst bed 102 may comprise a dense fluidized bed, the third catalyst bed 103 may comprise a turbulent fluidized bed, and the fourth catalyst bed 104 may comprise a dense fluidized bed. In embodiments where the first catalyst bed 101 is a turbulent or fast fluidized bed, the volume of the first catalyst bed 101 is substantially the same as the volume of the vessel containing the first catalyst bed 101 and the mass of catalyst present in the first catalyst bed 101 correlates to the density of the catalyst in the first catalyst bed 101. In embodiments where the second catalyst bed 102 is a dense fluidized bed, the volume of the second catalyst bed can vary depending on the height of the second catalyst bed 102 within the vessel containing the second catalyst bed 102 and the cross sectional area of the vessel containing the second catalyst bed 102. The amount of catalyst in the second catalyst bed 102 may correlate to the volume of the second catalyst bed 102 and the density of the second catalyst bed 102.

Likewise, in one or more embodiments where the third catalyst bed 103 is a turbulent or fast fluidized bed, the volume of the third catalyst bed 103 is substantially the same as the volume of the vessel containing the third catalyst bed 103 and the mass of catalyst present in the third catalyst bed 103 correlates to the density of the catalyst in the third catalyst bed 103. In embodiments where the fourth catalyst bed 104 is a dense fluidized bed, the volume of the fourth catalyst bed 104 can vary depending on the height of the fourth catalyst bed 104 within the vessel containing the fourth catalyst bed 104 and the cross sectional area of the vessel containing the fourth catalyst bed 104. The amount of catalyst in the fourth catalyst bed 104 may correlate to the volume of the fourth catalyst bed 104 and the density of the fourth catalyst bed 104.

In one or more embodiments, methods for controlling the catalyst flow through a fluidized catalytic processing system 100 comprise determining the amount of catalyst present in the first catalyst bed 101 of the fluidized catalytic processing system 100. As described herein, the “amount of catalyst” in a catalyst bed refers to the mass of the catalyst in the catalyst bed. The amount of catalyst present in the first catalyst bed 101 may be determined by any suitable means, including, but not limited to, correlating the amount of catalyst in the first catalyst bed 101 with a differential pressure measurement spanning the height of the first catalyst bed 101.

In one or more embodiments, methods for controlling the catalyst flow through a fluidized catalytic processing system 100 comprise comparing the amount of catalyst present in the first catalyst bed 101 with a threshold catalyst amount. As described herein, the “threshold catalyst amount” refers to a constant value representing the amount of catalyst in the first catalyst bed 101, which may be referenced to determine whether changes to the process should occur. In one or more embodiments, the threshold catalyst amount may be an amount of catalyst that the first catalyst bed 101 is designed to comprise at normal operating conditions; however, it should be noted that the threshold catalyst amount may be adjusted to any suitable value. Generally, comparing the amount of catalyst in the first catalyst bed 101 to a threshold catalyst amount comprises determining whether or not the amount of catalyst in the first catalyst bed 101 is greater than or equal to the threshold catalyst amount or less than the threshold catalyst amount. Comparing the value of the amount of catalyst in the first catalyst bed 101 to the threshold catalyst amount may be performed by any suitable means.

In one or more embodiments, when the amount of catalyst present in the first catalyst bed 101 is greater than or equal to the threshold catalyst amount, the method may comprise regulating the flow of catalyst from the second catalyst bed 102 to the third catalyst bed 103 such that a normal operating target amount of catalyst is maintained in the second catalyst bed 102. As described herein, a “normal operating target amount of catalyst” refers to a constant value representing the desired amount of catalyst in the second catalyst bed 102 when the fluidized catalytic processing system 100 is operating under normal conditions.

In one or more embodiments, when the amount of catalyst present in the first catalyst bed 101 is less than the threshold catalyst amount, the method may comprise regulating flow of catalyst from the second catalyst bed 102 to the third catalyst bed 103 such that an increased target amount of catalyst is maintained in the second catalyst bed 102. As described herein, the “increased target amount of catalyst” refers to a constant value representing the desired amount of catalyst in the second catalyst bed 102. In one or more embodiments, the increased target amount of catalyst may be within 10% of the sum of an adjustment factor and the normal operating target amount of catalyst in the second catalyst bed 102. For example, the increased target amount of catalyst may be within 10%, 9%, 8%, 7%, 6%, 5%, 4%, 3%, 2%, or even 1% of the sum of the adjustment factor and the normal operating target amount of catalyst in the second catalyst bed 102.

As described herein, the “adjustment factor” may be within 10% (±10%) of a difference between the amount of catalyst in the first catalyst bed 101 and the threshold catalyst amount in the first catalyst bed 101 when the amount of catalyst in the first catalyst bed 101 is less than the threshold catalyst amount in the first catalyst bed 101. For example, the adjustment factor may be within 10%, 9%, 8%, 7%, 6%, 5%, 4%, 3%, 2%, or even 1% of the difference between the amount of catalyst in the first catalyst bed 101 and the threshold catalyst amount in the first catalyst bed 101.

Without wishing to be bound by theory, it is believed that adjusting the target amount of the catalyst in the second catalyst bed 102 may increase the amount of catalyst held in the first catalyst bed 101 and second catalyst bed 102 of the fluidized catalytic processing system 100. If additional catalyst is not held in the first catalyst bed 101 and the second catalyst bed 102, then excess catalyst may accumulate in the fourth catalyst bed 104 of the fluidized catalytic processing system 100. If too much catalyst accumulates in the fourth catalyst bed 104, then the excess catalyst may flood a gas/solid separation device between the third catalyst bed 103 and the fourth catalyst bed 104. By increasing the amount of catalyst held in the second catalyst bed 102, the catalyst can be more evenly distributed between the second catalyst bed 102 and the third catalyst bed 103 of the fluidized catalytic processing system 100 and prevent the flooding of gas/solid separation device between the third catalyst bed 103 and the fourth catalyst bed 104.

In one or more embodiments, the amount of catalyst present in the first catalyst bed 101 is below the threshold catalyst amount because an insufficient amount of catalyst is passed from the fourth catalyst bed 104 to the first catalyst bed 101. An insufficient amount of catalyst may be passed from the fourth catalyst bed 104 to the first catalyst bed 101 when a means for regulating the flow of catalyst positioned between the fourth catalyst bed 104 and the first catalyst bed 101 restricts or prevents the flow of catalyst between the fourth catalyst bed 104 and the first catalyst bed 101. The means for regulating the flow of catalyst from the fourth catalyst bed 104 to the first catalyst bed 101 may restrict or prevent the flow of catalyst for various reasons, including, but not limited to, there being an insufficient amount of catalyst in the fourth catalyst bed 104. For example, a safety system trip could automatically block the flow from the forth catalyst bed 104 to the first catalyst bed 101.

In one or more embodiments, the amount of catalyst present in the first catalyst bed 101 may be below the threshold catalyst amount because an insufficient amount of catalyst is recycled from the second catalyst bed 102 to the first catalyst bed 101. An insufficient amount of catalyst may be recycled from the second catalyst bed to the first catalyst bed for a variety of reasons, including but not limited to, a low level of catalyst in the second catalyst bed 102 or the failure of a valve or other means for regulating catalyst flow in a recycle conduit between the second catalyst bed 102 and the first catalyst bed 101.

In one or more embodiments, the method for regulating the flow of catalyst from the second catalyst bed 102 to the third catalyst bed 103 may be accomplished by any suitable means for restricting the flow of catalyst, such as a valve. In one or more embodiments, the means for restricting the flow of catalyst may be adjusted to increase or decrease the rate of catalyst flow from the second catalyst bed 102 to the third catalyst bed 103. Since, in one or more embodiments, the amount of catalyst accumulating in the second catalyst bed 102 may be related to the flow of catalyst from the second catalyst bed 102 to the third catalyst bed 103, adjusting the means for restricting the flow of catalyst may change the amount of catalyst that accumulates in the second catalyst bed 102.

The methods for controlling the catalyst flow in the fluidized catalytic processing system 100 may be constrained by certain boundary conditions. In one or more embodiments, the methods for controlling catalyst flow may result in an increased amount of catalyst in the second catalyst bed 102. For example, the increased target amount of catalyst in the second catalyst bed 102 is always be larger than the normal operating target amount of catalyst in the second catalyst bed 102. In other words, the adjustment factor does not result in a decreased amount of catalyst in the second catalyst bed 102.

In one or more embodiments, the fluidized catalytic processing system 100 may be a fluidized catalytic process 400, an embodiment of which is depicted in FIG. 2. Generally, fluidized catalytic processes 400 may be used to produce a wide variety of products such as light olefins from hydrocarbon feed streams. Light olefins may be produced from a variety of hydrocarbon feed streams by utilizing different reaction mechanisms and different catalysts. It should be understood that when “catalysts” are referred to herein, they may refer to any suitable particulate solid useful for producing light olefins by various catalytic processes, such as dehydrogenation, cracking, dehydration, methanol to olefin, etc. Additionally, while some portions of the detailed description may describe the systems and processes described herein as a dehydrogenation system, other chemical reaction mechanisms are contemplated herein, and the presently claimed embodiments should not be limited to dehydrogenation systems unless explicitly stated.

Referring now to FIG. 2, the fluidized catalytic processing system 100 may comprise a reactor section 200 and a regenerator section 300. As used herein in the context of FIG. 2, a reactor section 200 generally refers to the portion of the fluidized catalytic processing system 100 in which the major process reaction takes place (e.g., dehydrogenation, cracking, dehydration, methanol to olefin, etc.), and the catalyst is separated from the olefin containing product stream of the reaction. In one or more embodiments the catalyst may be spent, meaning that the catalyst is at least partially deactivated. Also, as used herein, a regenerator section 300 generally refers to the portion of the fluidized catalytic processing system 100 where the catalyst is regenerated, such as through combustion, and the regenerated catalyst is separated from the other process material, such as evolved gasses from the combusted material previously on the spent particulate solids or from supplemental fuel. The reactor section 200 generally includes a reaction vessel 250, a riser 230 including an exterior riser segment 232 and an interior riser segment 234, and a first catalyst separation vessel 210. The regenerator section 300 generally includes a catalyst treatment vessel 350, a riser 330 including an exterior riser segment 332 and an interior riser segment 334, and a second catalyst separation vessel 310. Generally, the first catalyst separation vessel 210 may be in fluid communication with the catalyst treatment vessel 350, for example, by conduit 126, and the second catalyst separation vessel 310 may be in fluid communication with the reaction vessel 250, for example, by conduit 124.

Generally, the fluidized catalytic processing system 100 may be operated by feeding a hydrocarbon feed and fluidized catalyst into the reaction vessel 250, and reacting the hydrocarbon feed by contact with the fluidized catalyst to produce an olefin-containing product in the reaction vessel 250 of the reactor section 200. The olefin-containing product and the catalyst may be passed out of the reaction vessel 250 and through the riser 230 to a gas/solids separation device 220 in the first catalyst separation vessel 210, where the catalyst is separated from the olefin-containing product. The catalyst may be transported out of the first catalyst separation vessel 210 to the catalyst treatment vessel 350. In the catalyst treatment vessel 350, the catalyst may be regenerated by various processes. For example, the spent catalyst may be regenerated by one or more of oxidizing the catalyst by contact with an oxygen containing gas, combusting coke present on the catalyst, and combusting a supplemental fuel to heat the catalyst. The catalyst is then passed out of the catalyst treatment vessel 350 and through the riser 330 to a riser termination device 378, where the gas and catalyst from the riser 330 are partially separated. The gas and remaining catalyst from the riser 330 are transported to secondary separation device 320 in the second catalyst separation vessel 310 where the remaining catalyst is separated from the gasses from the regeneration reaction. The catalyst, separated from the gasses, may be passed to a catalyst collection area 380. The catalyst may undergo further treatment, such as oxidation, in the catalyst collection area 380. The separated catalyst is then passed from the catalyst collection area 380 to the reaction vessel 250, where it is further utilized. Thus, the catalyst may cycle between the reactor section 200 and the regenerator section 300.

As depicted in FIG. 2, the first catalyst bed 101 may be in reaction vessel 250. In one or more embodiments, the first catalyst bed 101 may be a turbulent or fast fluidized bed and may occupy substantially the entire volume of the reaction vessel 250. As described herein, “substantially the entire volume” may refer to at least 95% of the volume, at least 97% of the volume, or even at least 99% of the volume. The second catalyst bed 102 may be in the first catalyst separation vessel 210. In one or more embodiments, the second catalyst bed 102 may be a dense fluidized bed having an upper surface 122 and occupying at least a portion of the first catalyst separation vessel 210. The third catalyst bed 103 may be in catalyst treatment vessel 350. In one or more embodiments, the third catalyst bed may be a turbulent or bubbling fluidized bed and may occupy substantially the entire volume of the catalyst treatment vessel 350. The fourth catalyst bed 104 may be in the second catalyst separation vessel 310. In one or more embodiments, the fourth catalyst bed 104 may be a dense fluidized bed having an upper surface 144 and occupying at least a portion of the second catalyst separation vessel 310.

Without wishing to be bound by theory, it is believed that since the first catalyst bed 101 is a turbulent or fast fluidized bed and the second catalyst bed 102 is a dense fluidized bed, that the catalyst inventory in the reactor section 200 of the fluidized catalytic processing system 100 can be effectively controlled by controlling the amount of catalyst in the second catalyst bed 102. Since the amount of catalyst in the second catalyst bed 102 correlates to both the density of the bed and the volume of the bed, the first catalyst separation vessel 210 may be designed in a manner to accommodate varying amounts of catalyst to allow for control of the amount of catalyst in the reactor section 200 of the fluidized catalytic processing system 100. Likewise, in the regenerator section 300 of the fluidized catalytic processing system 100, since the third catalyst bed 103 is a turbulent or bubbling fluidized bed and the fourth catalyst bed 104 is a dense fluidized bed, the second catalyst separation vessel 310 may be designed to accommodate varying amounts of catalyst in the regenerator section 300 of the fluidized catalytic processing system 100.

In one or more embodiments, the flow of catalyst through conduit 126 may be regulated by valve 128. Valve 128 may be any suitable valve, including, but not limited to, a gate valve. In one or more embodiments, adjusting the position of valve 128 may change the flow rate of catalyst from the first catalyst separation vessel 210 to the catalyst treatment vessel 350. In one or more embodiments, the amount of catalyst in the first catalyst separation vessel 120 may be controlled by adjusting the position of valve 128. The position of valve 128 may be adjusted by any suitable means. For example, the position of valve 128 may be adjusted manually or by an electric, pneumatic, or hydraulic actuator.

In one or more embodiments, the flow of catalyst through conduit 124 may be regulated by valve 129. Valve 129 may be any suitable valve, including, but not limited to, a gate valve. In one or more embodiments, the catalyst flowing from the regenerator section 300 to the reactor section 200 contributes to the energy input to the reaction vessel 250 and valve 129 may be adjusted to maintain the energy balance of the fluidized catalytic process 400. Furthermore, the amount of catalyst circulating through the fluidized catalytic process 400 may be controlled by the position of valve 129. As such, in one or more embodiments, the position of valve 129 may be adjusted to maintain the material balance and energy balance of the fluidized catalytic process 400. The position of valve 129 may be adjusted by any suitable means. For example, the position of valve 129 may be adjusted manually or by an electric, pneumatic, or hydraulic actuator.

The first catalyst separation vessel 210 may comprise a catalyst collection area 280 in which the second catalyst bed 102 may be contained. In one or more embodiments, the catalyst collection area 280 may have a substantially constant cross sectional area. As described herein, a “substantially constant cross sectional area” refers to a cross sectional area that does not vary by more than 10%, 5%, 3%, 2%, or even 1%. In one or more embodiments, the catalyst collection area 280 may be generally cylindrical in shape (i.e., having a substantially circular diameter), or may alternately be non-cylindrically shaped, such as prism shaped with cross-sectional shaped of triangles, rectangles, pentagons, hexagons, octagons, ovals, or other polygons or curved closed shapes, or combinations thereof. In one or more embodiments, the riser 230 may pass through the catalyst collection area 280 and the catalyst collection area 280 may have a substantially annular shape.

In one or more embodiments, the catalyst collection area 280 may not have a constant cross sectional area. In such embodiments, the cross sectional area of the catalyst collection area 280 may vary over a height of the catalyst collection area 280. For example, the catalyst collection area 280 may comprise a conical section, a frusticonical section, a bulbous section, a curved section or any other suitable shape. In one or more embodiments, the catalyst collection area 280 may comprise a section having a substantially constant cross sectional area and a section having a non-constant cross sectional area.

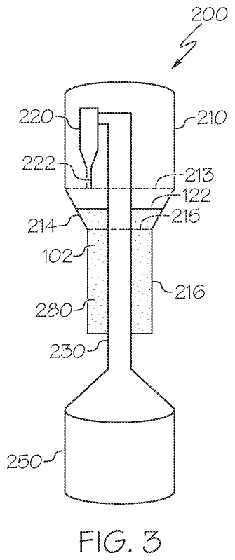

Referring to FIG. 3, the first catalyst separation vessel 210 may comprise a cylindrical section 216 and a frusticonical section 214. The frusticonical section 214 may be positioned above the cylindrical section 216. In one or more embodiments, the frusticonical section 214 may be directly connected to the cylindrical section 216 such that the cross sectional area of the frusticonical section 214 is substantially the same as the cross sectional area of the cylindrical section 216. The frusticonical section 214 may be directly connected to the cylindrical section 216 at level 215. In one or more embodiments, the cross sectional area of the frusticonical section increases over the height of the frusticonical section 214. In such embodiments, the frusticonical section 214 may have an average cross sectional area that is larger than the cross sectional area of the cylindrical section 216.

In one or more embodiments, the gas/solids separation device 220 may be a cyclonic separation system, which may include two or more stages of cyclonic separation. When the gas/solid separation device comprises a cyclonic separation system, the gas/solid separation device may comprise a dipleg 222 through which catalyst may pass into the catalyst collection area 280. In one or more embodiments, the dipleg 222 may extend into the frusticonical section 214 to level 213.

In one or more embodiments when the first catalyst separation vessel 210 has a shape similar to that depicted in FIG. 3, the flow of the catalyst from the second catalyst bed 102 to the third catalyst bed 103 may be regulated such that an upper surface 122 of the second catalyst bed 102 does not pass below the frusticonical section 214 of the catalyst separation vessel. For example, the upper surface 122 of the second catalyst bed may not pass below level 215 of the first catalyst separation vessel 210. Without wishing to be bound by theory, it is believed that keeping the upper surface 122 of the second catalyst bed 102 above level 215 of the first catalyst separation vessel 210 may ensure that there is enough catalyst present in the second catalyst bed 102 to consistently pass catalyst to the third catalyst bed 103 and/or recycle catalyst to the first catalyst bed 101. Additionally, keeping the upper surface 122 of the second catalyst bed 102 above level 215 of the first catalyst separation vessel 210 may facilitate accurate measurement the density of the second catalyst bed 102, as described in further detail herein.

Still referring to FIG. 3, in one or more embodiments, the first catalyst separation vessel 210 comprises a cyclone 220 having dipleg 222 extending into the fursticonical section 214. The flow of the catalyst from the second catalyst bed 102 to the third catalyst bed 103 may be regulated such that an upper surface 122 of the second catalyst bed 102 does not pass above the dipleg 222 of the cyclone at level 213 in the first catalyst separation vessel 210. Without wishing to be bound by theory, it is believed that keeping the upper surface 122 of the second catalyst bed 102 below the dipleg 222 at level 213 in the first catalyst separation vessel 210 may prevent the cyclone 220 from flooding, where flooding the cyclone 220 could interrupt the operation of the fluidized catalytic processing system 100.

While the catalyst collection area 280 of the first catalyst separation vessel 210 is described with regard to the reactor section 200 of the fluidized catalytic processing system 100, it is also contemplated that the catalyst collection area 380 of the regenerator section 300 of the fluidized catalytic processing system may share similar structure and system components such that the description of catalyst collection area 280 may also apply to catalyst collection area 380.

The methods for controlling catalyst flow in fluidized catalytic processing systems described herein may be performed using various measurement to determine the amount of catalyst in each of the catalyst beds. According to embodiments described herein, the amount or mass of catalyst may be determined from differential pressure measurements. Furthermore, in one or more embodiments, differential pressure measurements and values may be used to control the flow of catalyst through the fluidized catalytic processing system.

Differential pressure may correlate to the amount of catalyst in a catalyst bed as displayed in Equation 1.

$$DP = \frac{M}{V} * h * C \qquad Equation 1$$

In Equation 1, DP is the differential pressure, M is the mass of catalyst in the catalyst bed, V is the volume of the catalyst bed, h is the height of the catalyst bed over which the differential pressure is measured, and C is a unit conversion constant.

In one or more embodiments, the set point for valve 128 may be represented by Equation 2, where DP_{Control} is the control set point for the differential pressure measurement in the first catalyst separation vessel 210, DP_{Target} is the normal operating target differential pressure measurement in the first catalyst separation vessel 210, and DP_{Adj} is the adjustment factor that may be used when the amount of catalyst in the first catalyst bed 101 is low.

$${DP}_{Control} = {DP}_{Target} + {DP}_{Adj} \qquad Equation 2$$

As described hereinabove, in one or more embodiments, the differential pressure measurement spanning the first catalyst bed (DP_{First}) may be represented by Equation 3, where M_{First} is the mass of catalyst in the first catalyst bed 101, V_{First} is the volume of the first catalyst bed, h_{First} is the height of the first catalyst bed 101, and C is a unit conversion constant. In one or more embodiments, the first catalyst bed 101 may be a turbulent or fast fluidized bed in reaction vessel 250. In such embodiments, the first catalyst bed 101 may have a volume substantially equal to the volume of the reaction vessel 250 such that the volume and height of the first catalyst bed 101 are known or may be reasonably estimated. As such, Equation 3 could be rearranged to solve for the mass of the catalyst in the first catalyst bed 101.

$${DP}_{First} = \frac{{M}_{First}}{{V}_{First}} * {h}_{First} * C \qquad Equation 3$$

In one or more embodiments, the difference in the mass of catalyst in the first catalyst bed 101 may be calculated using Equation 4. In Equation 4, ΔM is the difference between the normal operating target amount of catalyst in the first catalyst bed 101 and the measured amount of catalyst in the first catalyst bed 101.

$$Δ M = \frac{( {DP}_{Threshold} - {DP}_{First} ) * {V}_{First}}{{h}_{First} * C} \qquad Equation 4$$

In one or more embodiments, Equation 4 may be used when DP_{First} is less than DP_{Threshold}. When DP_{First} equals zero, ΔM equals the normal operating target amount of catalyst in the first catalyst bed 101.

In one or more embodiments, DP_{adj} may be calculated as shown in Equation 5. Equation 5 follows the same general form as Equation 1 relating catalyst amount to a differential pressure measurement. In Equation 5, ΔM represents the amount of catalyst that is desired to be added to the second catalyst bed 102, ΔV is the fluidized volume of the amount of catalyst that is desired to be added to the second catalyst bed 102, and Δh is the bed height that is desired to be added to the second catalyst bed 102.

$${DP}_{adj} = \frac{Δ M}{Δ V} * Δ h * C \qquad Equation 5$$

In one or more embodiments, the second catalyst bed 102 may be a dense fluidized bed and may have a variable height. As such, the height of the second catalyst bed 102 may not be assumed to be constant. In one or more embodiments, an average density of the second catalyst bed 102 may be used to relate the amount of catalyst in the second catalyst bed 102 to the height of the second catalyst bed 102. A differential pressure measurement made within the second catalyst bed 102 (DP_{Second}) may be used to estimate the average density of the second catalyst bed 102. In one or more embodiments, this differential pressure measurement may be made as close to the upper surface 122 of the second catalyst bed 102 as possible, while still being fully within the second catalyst bed 102. Since density equals mass over volume, Equation 1 may be rearranged to solve for the density of the second catalyst bed, as shown in Equation 6.

$${ρ}_{Second} = \frac{{DP}_{Second}}{{h}_{Measurement} * C} \qquad Equation 6$$

In Equation 6, ρ_{Second} represents the density of the second catalyst bed 102, DP_{Second} represents a differential pressure measurement made within the second catalyst bed, and h_{Measurement} represents the height over which DP_{Second} is measured.

In one or more embodiments, the calculated density of the second catalyst bed 102 (ρ_{Second}) may be used to determine the additional volume (ΔV) displaced by the amount of catalyst desired to be added to the second catalyst bed 102 (ΔM) as shown in Equation 7.

$$Δ V = \frac{Δ M}{{ρ}_{Second}} \qquad Equation 7$$

In such embodiments, Equation 5 may be simplified as shown in Equation 8.

$${DP}_{adj} = {ρ}_{Second} * Δ h * C \qquad Equation 8$$

The desired change in the height of the second catalyst bed 102 may be solved for to satisfy the DP_{Adj} expression of Equation 8. In one or more embodiments, the cross sectional area of the second catalyst bed 102 is substantially constant. In such embodiments, the desired change in height of the second catalyst bed 102 (Δh) may be represented by Equation 9, where ΔV is the additional volume displaced by the amount of catalyst desired to be added to the second catalyst bed 102 and A is the cross sectional area of the second catalyst bed 102.

$$Δ h = Δ V / A \qquad Equation 9$$

Substituting Equations 7 and 9 into Equation 8 results in the expression for the adjustment factor DP_{adj} shown in Equation 10.

$${DP}_{adj} = \frac{Δ M}{A} * C \qquad Equation 10$$

Furthermore the adjustment factor DP_{adj} may be expressed in terms of the differential pressure measured across the first catalyst bed 101 (DP_{First}) as shown in Equation 11. However, it should be noted that Equation 11 is only valid when the cross sectional area of the second catalyst bed 102 is constant.

$${DP}_{adj} = \frac{( {DP}_{Threshold} - {DP}_{First} ) * {V}_{First}}{{h}_{First} * A} \qquad Equation 11$$

In one or more embodiments, the cross sectional area of the second catalyst bed 102 may not be substantially constant. In such embodiments, equations may be developed to relate the volume of the second catalyst bed to the height of the second catalyst bed. These equations may be expressed generically in Equations 12 and 13, where height the height of the second catalyst bed 102 is a function of the volume of the second catalyst bed 102 and the volume of the second catalyst bed 102 is the inverse function of the height of the second catalyst bed 102.

$$h = f ( V ) \qquad Equation 12$$

$$V = {f}^{- 1} ( h ) \qquad Equation 13$$

In one or more embodiments, solving for the desired change in the height (Δh) of the second catalyst bed 102 may include integrating the change in bed height over the change in bed volume from the normal operating volume of catalyst (V_{Set}) to the increased target volume of catalyst (V_{Set}+ΔV), as shown in Equations 15 and 16.

$$Δ h = dh = {\int }_{{V}_{set}}^{{V}_{set} + Δ V} {f}^{′} ( V ) dV \qquad Equation 15$$

$$Δ h = f ( {V}_{set} + Δ V ) - f ( {V}_{set} ) \qquad Equation 16$$

To complete the integration, the normal operating volume (Vₛₑₜ) of catalyst in the second catalyst bed 102 may be calculated as described herein. First, the height of the second catalyst bed may be calculated according to Equation 17, where h is the height of the second catalyst bed at the normal operating conditions, DP_{Target} is the normal operating target differential pressure measurement in the first catalyst separation vessel 210, and ρ_{Second} is the density of the second catalyst bed 102. Then, the normal operating volume (Vₛₑₜ) of catalyst in the second catalyst bed 102 may be calculated according to Equation 18.

$$h = \frac{{DP}_{Target}}{{ρ}_{Second} * C} \qquad Equation 17$$

$$Vset = dV = {\int }_{0}^{\frac{{DP}_{Target}}{{ρ}_{Second} * C}} {f}^{′ - 1} ( h ) dh \qquad Equation 18$$

Since volume equals zero when height equals zero, Equation 18 may be reduced, as shown in Equation 19.

$$Vset = {f}^{- 1} ( \frac{{DP}_{Target}}{{ρ}_{Second} * C} ) \qquad Equation 19$$

In such embodiments, the desired change in the height (Δh) of the second catalyst bed 102 may be expanded to the form shown in Equation 20.

$$Δ h = f ( \frac{{DP}_{Target}}{{ρ}_{Second} * C} + \frac{Δ M}{{ρ}_{Second}} ) - \frac{{DP}_{Target}}{{ρ}_{Second} * C} \qquad Equation 20$$

Equation 20 may be inserted into the expression for the adjustment factor DP_{adj} as shown in Equation 21.

$${DP}_{adj} = {ρ}_{Second} * C * f ( \frac{{DP}_{Target}}{{ρ}_{Second} * C} + \frac{Δ M}{{ρ}_{Second}} ) - {DP}_{Target} \qquad Equation 21$$

In Equation 21, the amount of catalyst desired to be added to the second catalyst bed 102 (ΔM) may be represented by Equation 4 and the density of the second catalyst bed 102 (ρ_{Second}) may be represented by Equation 6.

It should be noted that an explicit equation may be developed to relate the height of the second catalyst bed 102 to the volume of the second catalyst bed 102. In one or more embodiments, the equation may be a piecewise function. For example, a piecewise function may be appropriate where various portions of the vessel containing the second catalyst bed 102 have different geometries, such as the catalyst separation vessel 210 depicted in FIG. 3.

According to a first aspect of the present disclosure, the flow of catalyst in a fluidized catalytic processing system may be controlled by a method comprising determining the amount of catalyst present in a first catalyst bed of the fluidized catalytic processing system. The fluidized catalytic processing system may comprise a first catalyst bed, a second catalyst bed, a third catalyst bed, and a fourth catalyst bed. The first catalyst bed may be in fluid communication with the second catalyst bed. The second catalyst bed may be in fluid communication with the third catalyst bed. The third catalyst bed may be in fluid communication with the fourth catalyst bed. The fourth catalyst bed may be in fluid communication with the first catalyst bed. The catalyst circulates from the first catalyst bed to the second catalyst bed, from the second catalyst bed to the third catalyst bed, from the third catalyst bed to the fourth catalyst bed, and from the fourth catalyst bed to the first catalyst bed. Flow from the second catalyst bed to the third catalyst bed may be regulated to adjust the amount of catalyst in the second catalyst bed. The method may further comprise comparing the amount of catalyst present in the first catalyst bed with a threshold catalyst amount. When the amount of catalyst present in the first catalyst bed is greater than or equal to the threshold catalyst amount, the method may comprise regulating the flow of catalyst from the second catalyst bed to the third catalyst bed such that a normal operating target amount of catalyst is maintained in the second catalyst bed. When the amount of catalyst present in the first catalyst bed is less than the threshold catalyst amount, the method may comprise regulating flow of catalyst from the second catalyst bed to the third catalyst bed such that an increased target amount of catalyst is maintained in the second catalyst bed.

A second aspect of the present disclosure may include the first aspect where the amount of catalyst present in the first catalyst bed is below the threshold catalyst amount because an insufficient amount of catalyst is passed from the fourth catalyst bed to the first catalyst bed.

A third aspect of the present disclosure may include either the first or second aspects where an insufficient amount of catalyst is passed from the fourth catalyst bed to the first catalyst bed when a valve at least partially closes, where the valve is positioned in a conduit fluidly coupling the fourth catalyst bed and the first catalyst bed.

A fourth aspect of the present disclosure may include any of the first through third aspects where the amount of catalyst present in the first catalyst bed is below the threshold catalyst amount because an insufficient amount of catalyst is recycled from the second catalyst bed to the first catalyst bed.

A fifth aspect of the present disclosure may include any of the first through fourth aspects where the amount of catalyst present in a first catalyst bed of the catalytic processing system is determined by a differential pressure spanning a height of the first catalyst bed.

A sixth aspect of the present disclosure may include any of the first through fifth aspects where the increased target amount of catalyst is within 10% of the sum of an adjustment factor and the normal operating target amount of catalyst in the second catalyst bed.

A seventh aspect of the present disclosure may include the sixth aspect where the adjustment factor is within 10% of a difference between the amount of catalyst in the first fluidized bed and the threshold catalyst amount in the first fluidized bed when the amount of catalyst in the first fluidized bed is less than the threshold catalyst amount in the first fluidized bed.

An eighth aspect of the present disclosure may include any of the first through seventh aspects where regulating the flow of catalyst from the second catalyst bed to the third catalyst bed comprises adjusting a valve positioned in a conduit fluidly coupling the second catalyst bed and the third catalyst bed.

A ninth aspect of the present disclosure may include any of the first through eighth aspects where the second catalyst bed comprises a dense fluidized bed.

A tenth aspect of the present disclosure may include any of the first through ninth aspects where the first catalyst bed comprises a turbulent fluidized bed or a fast fluidized bed.

An eleventh aspect of the present disclosure may include any of the first through tenth aspects where the first catalyst bed is in a dehydrogenation reactor.

A twelfth aspect of the present disclosure may include any of the first through eleventh aspects where the third catalyst bed is in a catalyst treatment vessel.

A thirteenth aspect of the present disclosure may include any of the first through twelfth aspects where fourth catalyst bed is in a second catalyst separation vessel.

A fourteenth aspect of the present disclosure may include any of the first through thirteenth aspects where the second catalyst bed is in a first catalyst separation vessel.

A fifteenth aspect of the present disclosure may include the fourteenth aspect where the first catalyst separation vessel comprises a cylindrical section and a frustoconical section. where the frustoconical section is positioned above the cylindrical section, and where the frustoconcial section has an average cross sectional area larger than a cross sectional area of the cylindrical section.

A sixteenth aspect of the present disclosure may include the fifteenth aspect where the flow of the catalyst from the second catalyst bed to the third catalyst bed is regulated such that an upper surface of the second catalyst bed does not pass below the frustoconical section of the catalyst separation vessel.

A seventeenth aspect of the present disclosure may include either the fifteenth or the sixteenth aspects where the catalyst separation vessel comprises a cyclone having dipleg extending into the furstoconical section and the flow of the catalyst from the second catalyst bed to the third catalyst bed is regulated such that an upper surface of the second catalyst bed does not pass above the dipleg of the cyclone.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.” It should be understood that where a first component is described as “comprising” a second component, it is contemplated that, in some embodiments, the first component “consists” or “consists essentially of” that second component.

It should be understood that any two quantitative values assigned to a property may constitute a range of that property, and all combinations of ranges formed from all stated quantitative values of a given property are contemplated in this disclosure.

1. A method for controlling the catalyst flow in a fluidized catalytic processing system, the method comprising:
determining the amount of catalyst present in a first catalyst bed of the fluidized catalytic processing system, wherein the fluidized catalytic processing system comprises a first catalyst bed, a second catalyst bed, a third catalyst bed, and a fourth catalyst bed, wherein:
the first catalyst bed is in fluid communication with the second catalyst bed;
the second catalyst bed is in fluid communication with the third catalyst bed;
the third catalyst bed is in fluid communication with the fourth catalyst bed;
the fourth catalyst bed is in fluid communication with the first catalyst bed;
the catalyst circulates from the first catalyst bed to the second catalyst bed, from the second catalyst bed to the third catalyst bed, from the third catalyst bed to the fourth catalyst bed, and from the fourth catalyst bed to the first catalyst bed; and
flow from the second catalyst bed to the third catalyst bed is regulated to adjust the amount of catalyst in the second catalyst bed;
comparing the amount of catalyst present in the first catalyst bed with a threshold catalyst amount;
when the amount of catalyst present in the first catalyst bed is greater than or equal to the threshold catalyst amount, regulating the flow of catalyst from the second catalyst bed to the third catalyst bed such that a normal operating target amount of catalyst is maintained in the second catalyst bed; and
when the amount of catalyst present in the first catalyst bed is less than the threshold catalyst amount, regulating flow of catalyst from the second catalyst bed to the third catalyst bed such that an increased target amount of catalyst is maintained in the second catalyst bed.

2. The method of claim 1, wherein the amount of catalyst present in the first catalyst bed is below the threshold catalyst amount because an insufficient amount of catalyst is passed from the fourth catalyst bed to the first catalyst bed.

3. The method of claim 2, wherein an insufficient amount of catalyst is passed from the fourth catalyst bed to the first catalyst bed when a valve at least partially closes, where the valve is positioned in a conduit fluidly coupling the fourth catalyst bed and the first catalyst bed.

4. The method of claim 1, wherein the amount of catalyst present in the first catalyst bed is below the threshold catalyst amount because an insufficient amount of catalyst is recycled from the second catalyst bed to the first catalyst bed.

5. The method of claim 1, wherein the amount of catalyst present in a first catalyst bed of the catalytic processing system is determined by a differential pressure spanning a height of the first catalyst bed.

6. The method of claim 1, wherein the increased target amount of catalyst is within 10% of the sum of an adjustment factor and the normal operating target amount of catalyst in the second catalyst bed.

7. The method of claim 6, wherein the adjustment factor is within 10% of a difference between the amount of catalyst in the first fluidized bed and the threshold catalyst amount in the first fluidized bed when the amount of catalyst in the first fluidized bed is less than the threshold catalyst amount in the first fluidized bed.

8. The method of claim 1, wherein regulating the flow of catalyst from the second catalyst bed to the third catalyst bed comprises adjusting a valve positioned in a conduit fluidly coupling the second catalyst bed and the third catalyst bed.

9. The method of claim 1, wherein one or more of:
the second catalyst bed comprises a dense fluidized bed; and
the first catalyst bed comprises a turbulent fluidized bed or a fast fluidized bed.

10. The method of claim 1, wherein one or more of:
the first catalyst bed is in a dehydrogenation reactor; and
the third catalyst bed is in a catalyst treatment vessel.

11. The method of claim 1, wherein the fourth catalyst bed is in a second catalyst separation vessel.

12. The method of claim 1, wherein the second catalyst bed is in a first catalyst separation vessel.

13. The method of claim 12, wherein the first catalyst separation vessel comprises a cylindrical section and a frustoconical section, where the frustoconical section is positioned above the cylindrical section, and where the frustoconcal section has an average cross sectional area larger than a cross sectional area of the cylindrical section.

14. The method of claim 13, wherein the flow of the catalyst from the second catalyst bed to the third catalyst bed is regulated such that an upper surface of the second catalyst bed does not pass below the frustoconical section of the catalyst separation vessel.

15. The method of claim 13, wherein the catalyst separation vessel comprises a cyclone having dipleg extending into the frustoconical section and the flow of the catalyst from the second catalyst bed to the third catalyst bed is regulated such that an upper surface of the second catalyst bed does not pass above the dipleg of the cyclone.
